(19) United States
(12) Patent Application Publication
(10) Pub. No.: US 2006/0222430 A1
(43) Pub. Date: Oct. 5, 2006

(54) Linerless web feeding method and system

(76) Inventors: Jeanne F. Duckett, Franklin, OH (US); John R. Kessler, Dayton, OH (US)

Correspondence Address: PAXAR AMERICS, INC., 170 MONARCH LANE, MIAMISBURG, OH, 45342, US

(21) Appl. No.: 11/096,300

(22) Filed: Apr. 1, 2005

(51) Int. Cl. B41J 15/00

(52) U.S. Cl. 400/583; 400/582; 400/611

(57) ABSTRACT

A method and system operable in multiple modes of operation and including a web feeding mode and an idle mode. In the web feeding mode, the device operates to perform a function on a linerless web having tacky adhesive in contact with a feed roll by which the web is being moved or advanced. This function can be a printing function and/or an RFID and/or write function, or other functions. During the idle mode, the controller can cause the web feeding device to perform a cycling program to abate excessive sticking or bonding of the tacky linerless web to the feed roll.

### TECHNICAL FIELD

This invention relates to linerless web feeding systems such as printing devices, and/or RFID reader/writer devices, and methods of using such devices.

### BACKGROUND

Linerless label printing offers a number of advantages, not the least of which is the elimination of waste associated with liner disposal. Printing devices capable of processing linerless web stock are known. Such printing devices typically print on the advancing linerless web, and the advance of the web via the platen roll typically is stopped following printing so that the just-printed portion of the web such as a label, a receipt, or the like can be torn or cut from the web. Some of such printing devices rotate the platen roll through a slight angle in the reverse direction to bring the next label or receipt to the top-of-form position immediately prior to printing.

Still, linerless printing presents challenges not encountered in linered web label stock printing. For example, after periods during which the printing device remains idle, the tacky adhesive on the underside of the linerless web may become sufficiently adhered or stuck to the platen roll such that the web does not easily release from the platen roll upon resumption of operation. Sticking of the linerless stock to the platen roll may result in misprinting of labels and/or jamming of the linerless label printing device resulting in printer down time and requiring operator intervention. Sticking of the linerless web to the platen roll may occur notwithstanding the construction of the platen roll to resist bonding. Sticking of the web to the platen roll is further exacerbated by excessive dwelling of the adhesive-backed web in contact with one location on the platen roll and by environmental conditions such as ambient temperature and humidity and by print head pressure.

To prevent sticking of the linerless web to the platen roll during idle periods, the device operator may be advised to unload the linerless web from the printing device. Alternatively, the operator may be instructed to open the printing device and move the print head out of contact with the linerless web to eliminate the print head pressure on the linerless web. These steps require operator intervention which cannot be performed frequently enough to be practical, do not readily lend themselves for use with automatic label applicators, increase the time necessary to place the printing device in an operating condition after an idle period, and are easily overlooked or forgotten.

### BRIEF DESCRIPTION OF THE DRAWINGS

FIG. 1 is a schematic illustration of a linerless web feeding system in accordance with a described embodiment of the invention;

FIG. 2 is a block diagram illustration of a control system that may be incorporated into a linerless web feeding system;

FIG. 3 is a flow chart diagram illustrating a method of controlling a linerless web feeding system; and

FIG. 4 is a block diagram illustration of an alternate embodiment of a linerless web feeding system.

### DETAILED DESCRIPTION

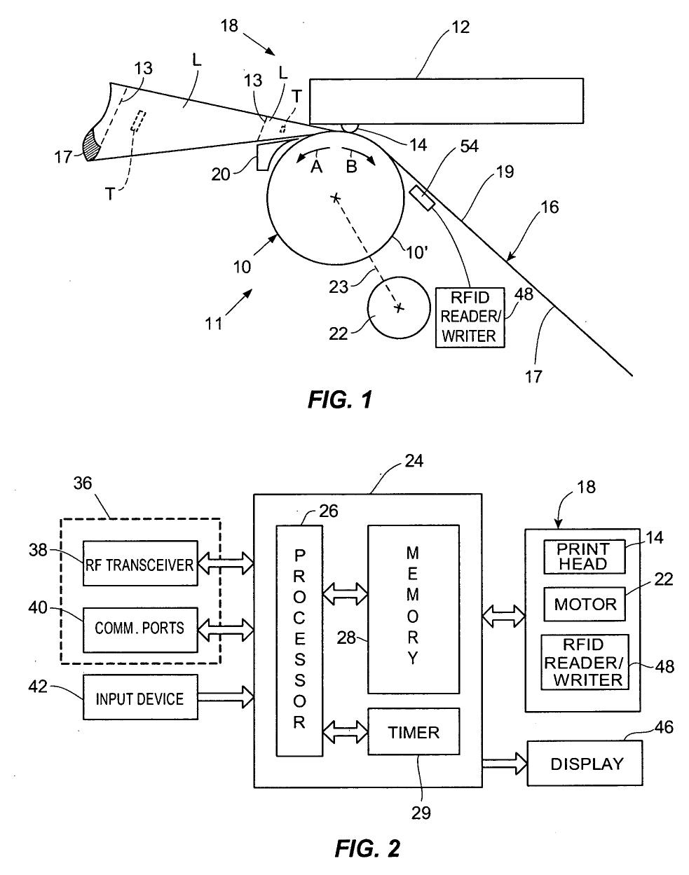

Referring to FIG. 1, the linerless web feeding system 11 including a printing device 18 is shown schematically to include a feed roll 10 which is shown to take the form of a platen roll 10′, and a print head unit 12 including a thermal print head 14 having a line of dot heating elements contacting a linerless web 16. The underside of the linerless web 16 includes a coating of tacky or pressure sensitive adhesive 17 which is in contact with the platen roll 10′. The web 16 also has a release coating on its upper surface 19 as is conventional. The web 16 may have transversely extending perforation lines 13 that divide the web 16 into a series of labels L or other record members. The web 16 is drawn from a supply roll (not depicted) over the platen roll 10′ and exits at the front of the printing device 18. A shelf 20 may be disposed adjacent the platen roll 10′ to assist in supporting the web 16 and directing the web 16 off the platen roll 10′ and out of the printing device 18.

The platen roll 10′, the print head unit 12, a drive motor 22, and a drive connection 23 such as gearing, are supported within a housing, and may further be supported within a subframe that itself is supported in a housing. The print head unit 12 including the thermal print head 14 and a heat sink, a printed circuit board, and a wiring connector and other required elements are all typically pivotably mounted as a unit relative to the platen roll 10′ to facilitate moving the print head 14 out of contact with the web 16 and the platen roll 10′ for servicing the print head or platen roll or for loading label stock. Additionally, the print head unit 12 may be spring biased to a printing position such that the print head 14 may be in adjustable pressure contact with the web 16. The particular physical structure of the printing device 18 does not form a part of the instant invention, and in particular, the invention claimed herein has application to virtually any type of printing device, including printing devices that utilize a print head and a platen. While the feed roll is shown as a platen roll, the platen roll need not be driven, as the advance of the web may be affected by another roll or rolls (not shown).

Typical linerless stock provides for thermal direct printing; however, other types of printing of linerless stock may be used including thermal transfer printing, non-thermal printing, and the like. The particular type of printing technology is not material to the claimed invention.

The platen roll 10′ may include a metallic, plastic or other suitable core covered with silicone rubber or another elastomeric material that facilitates release of the web 16 from the platen roll 10′ yet provides sufficient friction so that the platen roll 10′ is able to engage the web 16 for advancing or feeding the web 16 through the printing device 18. The surface of the platen roll 10′ may also include a texture or pattern that also serves to facilitate release of the web 16. Notwithstanding the material and texturing of the surface of the platen roll 10′, after idle periods during which the printing device is not operated, the web 16 may become undesirably adhered to the surface of the platen roll 10′ without action to abate the situation.

The drive motor 22 may be a stepper motor, direct current (DC) servo motor or any other suitable motor or device for providing a driving torque to the platen roll 10′. The particular type of the drive arrangement for the platen roll 10′ is not material to the claimed invention; however, as will be explained below, the drive arrangement is capable of driving the platen roll 10′ in a first or forward direction and a second or backward direction.

FIG. 2 illustrates a controller 24 for a linerless web feeding system, such as the linerless web feeding system 11 incorporating the printing device 18. The controller 24 includes a programmable processor 26 coupled to a memory 28 and a timer 29. The memory 29 may include several memory structures, and, a memory or memories such as flash, read only (ROM), random access (RAM), and/or EEPROM. The system memory 28 contains a control program readable and executable by the processor 26 for affecting operation of the linerless web system 11 and any associated device, such as the printing device 18. While shown as a single processing device, the processor 26 may include multiple processors; a digital signal processor (DSP), an application specific integrated circuit (ASIC) or any other suitable processing device. For purposes of this disclosure, a machine-readable or machine-accessible medium may include any mechanism that provides (i.e., stores and/or transmits) information in a form accessible by a machine (e.g., a computer, network device, personal digital assistant, manufacturing tool and/or any device having one or more processors and capable of processing, storing and/or transmitting information). For example, machine-readable or machine-accessible medium includes recordable/non-recordable media including ROM, RAM, magnetic disk storage, optical storage and flash memory as well as electrical, optical, acoustical or other forms of propagated signals (e.g., carrier waves, infrared signals, digital signals).

The controller 24 is communicatively coupled to a communication interface 36. The communication interface 36 is shown to include an RF transceiver 38 and/or one or more communication ports 40, such as an RS 232 port, a serial port, a parallel port, an 802.11b/g port, and 802.3 port, a universal serial bus (USB) port, a IEEE 1394 firewire port, etc. The communication interface 36 allows the printing device 18 to communicate with a host device to receive data therefrom or to transmit data thereto. The communication interface 36 further allows the controller 24 to communicate in real time. Alternatively, the controller 24 may receive data off-line such that received data is stored in the memory 28. The controller 24 can be further coupled to a user interface that can include an input device 42 such as a keypad, touch screen, trigger or the like and an output device 46 such as a display.

The linerless web system 11 may further include a radio frequency identification (RFID) reader/writer 48 coupled to an antenna 54 and that is also communicatively coupled to the controller 24. The RFID reader/writer 48 is capable of reading and/or writing to an RFID transponder T that is contained within the linerless stock, e.g., the web 16. The system 11 and its RFID reader/writer 48 preferably takes the form disclosed in co-owned pending U.S. patent application Ser. No. 10/873,979 filed Jun. 22, 2004, the disclosure of which is incorporated herein by reference. The RFID reader/writer 48 and the antenna 54 operate to read data from, and/or write data into, the transponders T in the web 16.

In general operation of the linerless web system 11, referred to herein as a printing mode of operation, the controller 24, is operable in connection with the control program to receive data from an input device 38, 40 or 42 and to manipulate the received data and/or combine it with data received from a different input source or stored within the memory 28. The controller 24 couples the received, manipulated and/or combined data to the printing device 18 for printing on the web 16 and/or writing to or reading from RFID transponders T disposed within the web 16 to create labels L. The controller 24 also commands the motor 22 to drive the platen roll 10′ while simultaneously affecting operation of the print head 14 and/or the RFID reader/writer 48.

The printing device 18 is designed for and will often see substantially continuous use in the printing mode. The printing mode does not present problems with respect to the web 16 becoming adhered or otherwise sticking to the platen roll 10′ because during such operation the platen roll 10′ pauses only briefly between the creation of record members. Such brief pauses leave insufficient time for the adhesive of the web 16 to adhere strongly to and hence become stuck to the platen roll 10′.

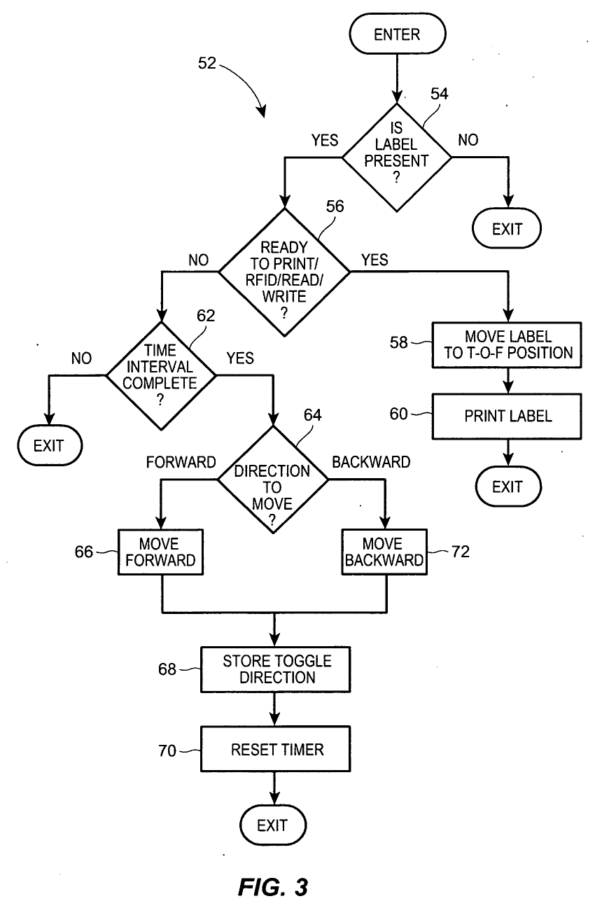

An idle period follows the printing of a label L or other record members. The idle period may be any period of time longer than the brief pauses that generally occur between creation of record members during the printing mode of operation of the printing device 18. This typically longer time-period is referred to herein as an idle mode. Typically, however, an idle period will be a period of time during which the printing device 18 is not operated to create record members or otherwise advance the web 16 over the platen roll 10′. During the idle mode, the controller 24 implements a cycling program 52 as shown in FIG. 3 for abating the occurrence of the web 16 sticking to the platen roll 10′.

The flow chart in FIG. 3 for the system 11 illustrates the operation of the printing device 18 and/or the RFID reader/writer 48 and, in particular, illustrates the cycling program 52 that controls operation of the motor 22 and the motions of the platen roll 10′. The program 52 is notified as to whether or not a label L is present as shown at block 54. If no label L is present, the program is exited. If a label L is present, a decision is made at block 56 as to whether or not a label L is ready to be printed and/or RFID encoded. If a label L is ready to be printed and/or encoded, the motor 22 moves the platen roll 10′ to bring the leading unprinted and/or unencoded label to the top-of-form (T-O-F) position as shown in block 58. The label L then is printed and/or encoded as shown at block 60, after which the program is exited. This continues so long as the decision block 56 determines that a label L is ready to be printed. If, however, the decision at block 56 is that the label L is not ready to be printed or encoded, the program 52 makes a decision at block 62 as to whether or not the time interval since the last label L was printed and/or encoded is complete, that is, whether or not the time has been exceeded as determined by the timer 29. If the time for which the timer 29 is set is incomplete, that is, has not been exceeded, the program is exited. If the time for which the timer 29 is set has been exceeded, a decision needs to be made, as at block 64, whether the web 16 needs to be moved in the forward direction or in the backward direction. If the web 16 is to be moved in the forward direction, the motor 22 is operated to move the web 16 forward by a predetermined amount as shown at block 66. The direction of the sequencing of the roll 10′ is stored at block 68. For example, the controller 24 stores the instruction of the number of steps of the stepping motor or the distance a DC motor is to move the web 16 forward or backward. The memory 28 stores the direction that the web 16 was advanced. Thereupon, the timer 29 is reset as indicated at block 70. The next time the block 62 determines that the time interval is complete, the motor 22 is operated to move the web 16 backwards or in the upstream direction as indicated at block 72, and the memory 28 stores the direction in which the web 16 was advanced as indicated at block 68, and the timer 29 is reset as indicated at block 70. It is apparent that the controller 24 and the program 52 operate to control the forward and backward movements of the platen roll 10′. Even though the cycling program 52 has been illustrated with respect to one advance or one set of steps of the motor 22 in the forward or downstream direction followed by either one backward or upstream movement or one set of steps of the motor, the memory 28 can be set or controlled to move in two or more forward movements or series of steps followed by either one or more movements or one or more series of steps in the backward direction. It is preferred that upon completion of the cycling program 52, the web 16 is preferably near but spaced from the top-of-form position. In the case of an RFID record member, it is preferred that the web 16 is positioned so that the reader-writer 48 is able to read and/or write to the transponder T.

Should the printing device 18 receive a command to perform a printing operation, the printing operation command interrupts the idle mode process and places the printing device 18 back in the printing mode. Upon completion of the printing operation, i.e., the end of the printing mode, the printing device 18 may return to the idle mode. It will be additionally appreciated that the idle mode need not be immediately entered. The controller 24 may implement a dwell period following completion of a printing operation wherein the printing device 18 remains in the printing mode. Upon expiration of the dwell period, the controller 24 may then cause the printing device 18 to enter the idle mode, implementing the as herein described idle mode process.

Generally speaking, the printing device 18 may be considered to have at least two modes of operation, including a printing mode and an idle mode, as determined and controlled by the controller 24. In the printing mode, the printing device 18 operates to create record members. In the idle mode, unless interrupted to return to the printing mode, the controller 24 causes the printing device 18 to perform a cycling program to abate sticking of the linerless web 16 to the platen roll 10′.

The cycling process may take several different forms. In one embodiment, the cycling for controller 24 commands the motor 22 to move the platen roll 10′ through a first angular range in a first direction A and then through a second angular range in a second direction B, or vice versa, and to move the web 16 correspondingly. For example, the controller 24 may command the motor 22 to advance the platen roll 10′ to cause the web 16 to move forward and then to retract the web 16 by reversing the platen roll 10′. The first angular range and the second angular range may be substantially the same, but not necessarily so. Precise control of the position of the web 16 relative to the print head 14 is generally desired. The controller 24 will retain in the memory 28 information relating to the top-of-form position in view of the cycling program to ensure the web 16 is returned to the top-of-form position at the start of a printing operation. Alternatively, the printing device 18 and the web 16 may be configured with recognizable indicia or registration marks, apertures, or the like allowing the controller 24 to determine precisely the top-of-form position of the web 16 for creating a record member.

The direction of movement and range need only be sufficient to momentarily free the web 16 from the platen roll 10′. Thus, it is possible for the cycling program 52 to cause movement only in a single direction or alternately moving the web in the first direction by one or more increments or series of steps and thereafter in the second and opposite direction in one or more increments or series of steps. The angular ranges and the direction of movement may further be chosen such that the portion of the web 16 under the print head 14 at the start of the cycling program does not remain under the print head 14 upon conclusion of the cycling program. It will be appreciated that many different embodiments of the cycling program may be envisioned, all of which cannot be described herein.

In an exemplary embodiment, not by way of limitation, the motor 22 is a stepper motor or a DC motor, and the controller 24 commands the motor 22 to move a defined number of steps or distance. For example, the controller 24 may command the motor 22 to advance 20 steps, correlating to approximately 0.125 mm (0.005″) of the web 16. Next, the controller 24 commands the motor 22 to retract 20 steps returning the web 16 to its initial position. However, as noted, the distances are predefined and the web 16 may be moved substantially more or less than 0.125 mm. The web 16 should be moved a distance and an amount at least sufficient to cause the web 16 to release from or break the bond with the platen roll 10′. In this particular described embodiment, the web 16 may be moved as little as 0.025 mm (0.001″), i.e., five motor steps, or as much as 2.5 mm (0.1″) or more. It is desirable to keep the movement as small as will allow release of the adhesive 17 on the web 16 from the platen roll 10′, and use of different motor technologies for the motor 22, e.g., half-step stepper motors, DC servo motors, etc. may permit still smaller movements of the web 16.

By other embodiments, the platen roll 10′ could be operated to move the web 16 forward by a small increment e.g. 0.025 mm, and again one or more times by 0.025 mm at predetermined intervals as determined by the program, and thereafter the platen roll 10′ and the web 16′ can be moved backward in steps of 0.025 mm at predetermined intervals as determined by the cycling program an equal number of times so that the web 16 is returned to its initial position. If desired, the backward movement could be accomplished with one or more steps lasting a predetermined time interval or the web can be returned to its initial position by one continuous movement.

The cycling program may further be implemented to utilize different distances with each subsequent implementation of the cycling program, or may implement a pattern of distances. That is, in accordance with the cycling program, the controller 24 may command the motor 22 to advance and retract the web 16 by first distances during a first instance of the cycling program and second distances during a second or subsequent instance of the cycling program. The distances may be selected or determined from a table stored in the memory 28.

The predetermined time period, as measured by the timer 29, during which the printing device 18 remains in the idle mode may be preset and fixed upon manufacture of the printing device 18, user settable via the input device 42, automatically settable based upon recognition by the printing device 18 and controller 24 of the type of linerless stock being used in the printing device 18, automatically set based upon sensed environmental conditions or by any suitable means. As noted, the tendency of the web 16 to become bonded or adhered to the platen roll 10′ depends on a number of factors including the type of adhesive, the print head pressure, operating temperatures and various environmental factors.

The predetermined time period may be as short as 300 milliseconds or less, or any desired greater period of time. In an exemplary embodiment, the controller 24 may be programmed to dwell approximately 5-30 seconds upon completion of a printing operation before entering the idle mode. Once in the idle mode, the controller 24 may wait approximately 5 minutes to initiate the cycling program, and will reinitiate the cycling program every 5 minutes thereafter until a printing operation is received and the printing device 18 is returned to the printing mode. The controller 24 may implement a software timer to track these periods. Alternatively, a clock timer may be provided within the controller 24.

Should a printing operation be received during the cycling program, the controller 24 would process the received job as normally expected. The motor 22 would immediately return the platen roll 10′ to the correct print position when the web 16 is at top-of-form. Alternatively, the controller 24 may disable the communication interface 36 during the cycling operation, causing the data sending entity to receive a communication error message. Still as a further alternative, the controller 24 may cause the received data to be stored in the memory 28 and upon completion of the cycling program the printing operation is completed by retrieving the stored information from the memory 28.

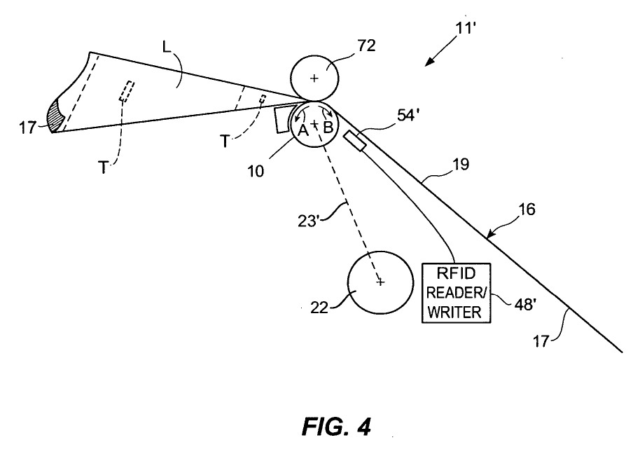

FIG. 4 illustrates schematically a linerless web feeding system 11′ in accordance with an alternative embodiment of the invention that includes a RFID reader/writer device 48′. Like reference numerals are used to identify like elements described in connection with the embodiment of the linerless web system 11 illustrated in FIG. 1 while primed reference numerals indicate alternative elements. The system 11′ is like the system 11 except that printing structure is omitted and the labels L are not printed by the system 11′. As in the system 11, the system 11′ advances the web 16 when the feed roll 10 moves in direction A and retreats the web 16 when the feed roll 10 moves in direction B. The system 11′ includes the feed roll 10 coupled at 23′ via, for example, suitable gearing, etc. (not depicted) to a drive motor 22, and also includes a controller such as the controller 24. The feed roll 10 engages and draws the web 16 from a supply roll (not depicted). A back up or nip roll 72 is optionally disposed opposite the feed roll 10 to contact and press the web 16 against the feed roll 10. The underside of the web 16 includes a coating of tacky or pressure sensitive adhesive 17 in contact with the feed roll 10 and a release coating on its upper surface 19. The web 16 exits at a front of the system 11′. The web 16 may be pre-scored or perforated to define individual record members L, with each record member L incorporating an RFID transponder T. Alternatively, the system 11′ may be adapted to score or cut the web 16 as individual record members L are created, as would be the case when the web 16 is continuous. The upper surface 19 of the web 16 may be pre-printed or otherwise processed to include graphics, text or other indicia.

The system 11′ includes an RFID reader/writer 48′ coupled to an antenna 54′ and the controller 24. The system 11′ is operable to read data from and/or write data into transponders T as described in the aforementioned and incorporated U.S. patent application Ser. No. 10/873,979, filed Jun. 22, 2004. The record members L separated from the web 16 may be used for article/personnel surveillance, inventory control, or any other suitable purpose for which RFID transponder tags may be used.

The system 11′ may further advantageously incorporate the use of the cycling program 52 to abate sticking of the web 16 to the feed roll 10. The cycling program implemented within the associated controller 24 may be in accordance with any of the herein described embodiments or modifications thereof. In this regard, and analogous to the described embodiments, the system 11′ may have a record member creation mode of operation corresponding to the described print mode of operation and an idle mode of operation.

The record member creation mode does not present problems with respect to the web 16 becoming adhered or otherwise sticking to the feed roll 10 because during such operation the feed roll 10 pauses only briefly between the creation, i.e., encoding and/or decoding information to/from the transponders T of the record members L. Such brief pauses leave insufficient time for the adhesive of the web 16 to adhere strongly to and hence become stuck to the feed roll 10. However, the RFID reader/writer device 48′ may also experience idle periods.

An idle period may be any period of time longer than the brief pauses generally between creation of record members during record member creation mode operation of the RFID reader/writer device 48′ of the system 11′. This is referred to herein as an idle mode. Typically, however, an idle period will be a period of time during which the RFID reader/writer device 48′ is not operated to create record members or otherwise advance the web 16 over the feed roll 10. The idle period is sufficiently long so as to allow the adhesive 17 on the web 16 to adhere the web 16 to the feed roll 10, such that the web 16 becomes stuck to the feed roll 10 and does not freely release from the feed roll 10. During the idle mode, the controller implements the cycling program for abating the occurrence of the web 16 sticking to the feed roll 10.

The invention has been described in terms of several embodiments, including a number of features and functions. Not all features and functions are required for every embodiment of the invention, and in this manner the invention provides a printing device, controller, control program and method to abate sticking of linerless web material to a platen roll of the printing device. The features discussed herein are intended to be illustrative of those features that may be implemented; however, such features should not be considered exhaustive of all possible features that may be implemented in a device configured in accordance with the embodiments of the invention. Features of the described embodiments are understood to be interchangeable. Moreover, the herein described embodiments are illustrative, not limiting of the invention. The invention is best defined by the following claims.

We claim:

1. A method of controlling a device having a motor, a feed roll driven by the motor to feed a linerless web having tacky adhesive contacting the feed roll, and a controller for controlling the motor to move the feed roll, the method comprising: providing a linerless web having tacky adhesive contacting the feed roll; determining that the device has remained idle for a predetermined time period; and operating the motor to cause the feed wheel to move the web when the predetermined time period has been exceeded.

2. The method of claim 1, comprising operating the motor in accordance with a cycling program.

3. The method of claim 2, wherein the cycling program separately cycles the feed roll at spaced time intervals until the motor is required to feed the web.

4. The method of claim 2, wherein a cycle of the cycling program involves moving the feed wheel and the web in one direction followed by moving the feed wheel and the web in the opposite direction.

5. The method of claim 4, including repeating the cycle of the cycling program until the motor is required to feed the web.

6. The method of claim 1, wherein the device includes a printing device having a print head, and the feed roll is a platen roll with which the print head can cooperate to print on the web, including the step of printing on the web after completion of the operation of a cycling program.

7. The method of claim 1, wherein the device includes an RFID reader and/or writer to decode and/or encode RFID transponder(s) in the web, including the step of decoding and/or encoding RFID transponder(s) in the web after completion of the operation of a cycling program.

8. The method of claim 1, wherein the device is an RFID printer having a print head, and the feed wheel is a platen roll with which the print head can cooperate to print on the web, and wherein the RFID printer includes an RFID reader and/or writer to decode and/or encode RFID transponder(s) in the web, including the step of printing on the web and/or decoding and/or encoding RFID transponder(s) in the web after completion of the operation of a cycling program.

9. The method of claim 1, comprising automatically or manually setting the predetermined time period within a memory of the device.

10. The method as defined in claim 1, wherein the feed wheel is moved in the one direction and stopped at least once before the feed wheel is moved in the opposite direction.

11. The method as defined in claim 1, wherein the feed wheel is moved in one direction through a first angular range and thereafter in the opposite direction through the same angular range.

12. A linerless web feeding device comprising:
a feed roll driven by a motor to feed a linerless web having tacky adhesive contacting the feed roll, and a controller for directing operation of the motor to move the feed roll, the controller being operable to determine that the device has remained idle for a predetermined time period and to operate the motor to move the feed roll to cause the feed wheel to move the web when the predetermined time period has been exceeded.

13. The linerless web feeding device of claim 12, wherein the feed wheel is moved in the one direction and stopped at least once before the feed wheel is moved in the opposite direction.

14. The linerless web feeding device of claim 12, comprising a cycling program defining how the feed roll is caused to move the web, wherein the cycling program defines separate cycles of the feed roll at spaced time intervals until the device is required to feed the web.

15. The linerless web feeding device of claim 14, wherein a cycle of the cycling program involves moving the feed wheel and the web in one direction followed by moving the feed wheel and the web in the opposite direction.

16. The linerless web feeding device of claim 14, wherein the device includes a printing device having a print head, and the feed roll is a platen roll with which the print head can cooperate to print on the web, the controller being operable to affect printing on the web after completion of the operation of the cycling program.

17. The linerless web feeding device of claim 14, wherein the device includes an RFID reader and/or writer to decode and/or encode RFID transponder(s) in the web, the controller being operable to affect decoding and/or encoding RFID transponder(s) in the web after completion of the operation of the cycling program.

18. The linerless web feeding device of claim 14, wherein the device is an RFID printer having a print head, and the feed wheel is a platen roll with which the print head can cooperate to print on the web, and wherein the RFID printer includes an RFID reader and/or writer to decode and/or encode RFID transponder(s) in the web, the controller being operable to affect printing on the web and/or decoding and/or encoding RFID transponder(s) in the web after completion of the operation of the cycling program.

19. The linerless web feeding device of claim 14, wherein the cycling program repeatedly cycles the platen roll at spaced time intervals within the idle period.

20. A method of controlling a RFID reader/writer device, the RFID reader/writer device including a feed roll, a motor for moving the feed roll, a linerless web having tacky adhesive contacting the feed roll, a controller for directing operation of the motor to drive the feed roll for moving the linerless web, an antenna disposed adjacent the linerless web and an RFID reader/writer coupled to the antenna for encoding/decoding transponders disposed within the linerless web, the method comprising:
determining that the RFID reader/writer device has remained idle for a predetermined time period; and
cycling the feed roll through at least one cycle in accordance with a cycling program to cause the feed roll to move the web when the predetermined time period has been exceeded.
